(19) United States
(12) Patent Application Publication
(10) Pub. No.: US 2021/0042398 A1
(43) Pub. Date: Feb. 11, 2021

(54) Validation of Properties of a User Device in a Network

(71) Applicant: PulsePoint, Inc., New York, NY (US)

(72) Inventor: Rajesh Volluru, East Brunswick, NJ (US)

(73) Assignee: PulsePoint, Inc., New York, NY (US)

(21) Appl. No.: 16/986,206

(22) Filed: Aug. 5, 2020

Related U.S. Application Data
(60) Provisional application No. 62/884,530, filed on Aug. 8, 2019.

(51) Int. Cl. G06F 21/31; G06F 9/54; G06Q 30/00; G06Q 30/02; G06Q 20/40

(52) U.S. Cl. CPC G06F 21/31; G06F 9/547; G06Q 30/0185; G06N 20/00; G06Q 20/40; G06F 2221/2133; G06Q 30/0248

(57) ABSTRACT

A method, and a computer with instructions for performance of the method. An applet runs on a user device of the internet. Using a reliable interface on the user device, the applet has captured validation data describing the user device and software execution on the user device.

The captured validation data are stored. The validation data includes at least a unique device ID for the user device, and a session ID for a program running on the user device. When a service provider server receives a service request from the user device, data for the request are received at the validation server. Data from the request are compared against the stored validation data. The compared data include at least a device ID and session identifier. The validation server reports validation or refusal of validation depending on whether the comparing determines a match or mismatch between the request data and the stored validation data.

### BACKGROUND

This application claims benefit, as a non prov. of provisional of U.S. Provisional App. Ser. No. 62/884,530, filed Aug. 8, 2019. The entire disclosure of the '530 application is incorporated by reference

This application relates to program control systems in which peripherals have a key to determine kind of peripheral, and to transferring data among a plurality of spatially distributed computers or digital data processing systems via one or more communications media.

### SUMMARY

In general, in a first aspect, the invention features a method, and a computer with instructions for performance of the method. An applet runs on a user device of the internet. The applet has captured from a tamper-resistant interface on the user device validation data describing the user device and software execution on the user device. The captured validation data are stored at a validation server of the internet. The validation data includes at least a unique device ID for the user device, and a session ID for a program running on the user device. When a service provider server receives a service request from the user device, data for the request are received at the validation server. Data from the request are compared against the stored validation data. The compared data include at least a device ID and session identifier. If the comparing determines a match between the request data and the stored validation data, the service provider server receives report that the request is validated. If the comparing shows a mismatch, it is reported that the request is not validated.

In general, in a second aspect, the invention features a method, and a computer with instructions for performance of the method. An applet running on a user device of the internet has captured from a tamper-resistant interface on the user device validation data describing the user device and software execution on the user device. The captured validation data are stored at a validation server of the internet, the validation data including at position data of the user device. When a service provider server receives a service request from the user device, the validation server evaluates the request data and the stored validation data to evaluate whether the user device is operated by a human or is under operation of a bot. The validation server reports to the service provider server the result of the human vs. bot evaluation.

In general, in a third aspect, the invention features an apparatus. The apparatus has one or more processors and one or more nontransitory memories. The memories have stored therein programs that, when executed, cause the processor(s) to act as follows. The memory of a computer stores validation data captured by one or more programs running on a user device of the internet. The on-device program(s) captured the validation data from a tamper-resistant interface on the user device. The validation data describe the user device, software execution on the user device, a unique device ID for the user device, a session ID for a program running on the user device, and position data of the user device. When a service provider server receives data from the user device requesting a service, a computer evaluates the request data and the stored validation data to verify whether the user device is operated by a human as represented in the service request data or is under operation of a bot. If the verification succeeds, a network message is sent to the service provider server that the request is validated as coming from a device operated by a human. If the verification fails, a message is sent reporting that the request originated with a device operated by a bot.

In general, in a fourth aspect, the invention features an apparatus. The apparatus has one or more processors and one or more nontransitory memories. The memories have stored therein programs that, when executed, cause the processor(s) to act as follows. The memory of a computer stores validation data captured by one or more programs running on a user device of the internet. The on-device program(s) captured the validation data from a tamper-resistant interface on the user device. The validation data describe the user device, software execution on the user device, a unique device ID for the user device, and a session ID for a program running on the user device. When a service provider server receives data from the user device requesting a service, a computer evaluates the request data and the stored validation data to verify whether the user device is as represented in the service request data. If the verification succeeds, a network message is sent to the service provider server reporting that the request is validated. If the verification fails, a network message is sent to the service provider server reporting that the request is not validated.

In general, in a fifth aspect, the invention features an apparatus. The apparatus has one or more processors and one or more nontransitory memories. The memories have stored therein programs that, when executed, cause the processor(s) to behave as follows. A computer memory stores validation data captured by one or more programs running on a user device of the internet. The on-device program(s) capture the validation data from a tamper-resistant interface on the user device. The validation data describe the user device, software execution on the user device, and position data of the user device. When a service provider server receives data from the user device requesting a service, a computer evaluates the request data and the stored validation data to verify whether the user device is operated by a human or is under operation of a bot. A computer network message to the service provider server reports the result of the human vs. bot verification.

Particular embodiments may include one or more of the following features, singly or in any combination For multiple user devices running disparate operating systems, the on-device program(s) may be programmed to expose a uniform API (application program interface) to service provider servers, to allow service provider servers to obtain validation data from the multiple user devices over the uniform API, without the need to specialize to the disparate operating systems of the respective user devices. The verification may be designed to test for misrepresentation by an application on the user device. The on-device program may be programmed to run substantially continuously in background to collect validation data on the user device, and the validation data are stored longitudinally. Analysis of the stored longitudinal data may analyze a validation property of the user device. The captured validation data may be stored, and the evaluation of request data against validation data may be executed, both on the user device. The captured validation data may be stored, and comparing of request data against validation data may be executed, both on a validation server remote from the user device. The on-device program may be programmed to collect information on demand, per invocation by the validation server. The on-device program may be programmed to collect validation information on demand based on occurrence of at least three events from the following list: Page Load, Page Unload, Window Close, User navigates to page, User navigates off page, or User types Enter to initiate a POST. The program(s) may be programmed to cause the processor(s), as part of the verification, to test at least five parameters from the following list of parameters: user unique ID; User session ID; Domain; Operating System or Platform; Device location latitude/longitude; User agent; Device type; Device manufacturer; Device model; Device IP address; Carrier; Ad size; Application ID; App Name; Platform; Device Name; Web Page URL; Page Referrer for Web Pages; IP address; User Agent; Location latitude/longitude; Advertiser ID; Event name; and Device Orientation. The service request from the user device may relate to display of an ad. The service request from the user device may relate to validation for a financial transaction. The service request from the user device may relate to validation for access to digital content. The service request from the user device may relate to validation of access rights to a computer system or network. Evaluation of the stored validation data may include evaluating for an unusually large number of requests received from the same device ID within a recent time interval, relative to other devices or the same device ID for an earlier time interval. Evaluation of the stored validation data may include evaluating for atypical device orientation for a function relative to device orientation usage by other devices performing the same or similar functions. Evaluation of the stored validation data may include evaluating for atypical geographic location or geographic path. Evaluation of the stored validation data may include evaluating for atypical pattern of network connection. Evaluation of the stored validation data includes evaluating for atypical length of user session. Evaluation of the stored validation data includes evaluating for atypical battery usage. Evaluation of the stored validation data may include evaluating for atypical typing pattern or keyboard and mouse usage. Evaluation of the stored validation data may include evaluating for atypical connection destination and duration. the service request from the user device relates to display of an ad.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### DESCRIPTION OF THE DRAWINGS

FIGS. 1, 2, and 3 are block diagrams of a computer system.

FIGS. 4, 5, and 6 are flow charts.

### DESCRIPTION

The Description is organized as follows.
I. Introduction and Overview
II. Validation of User Device Properties in Response to Programmatic Request

ILA. General Operation

II.B. Implementation

II.C. Validating a User Device Request

II.D. Validating a User Session

ILE. Validating Against Misrepresented Data
III. Validation of Human vs. Bot Devices
IV. Computer Implementation
I. Introduction and Overview

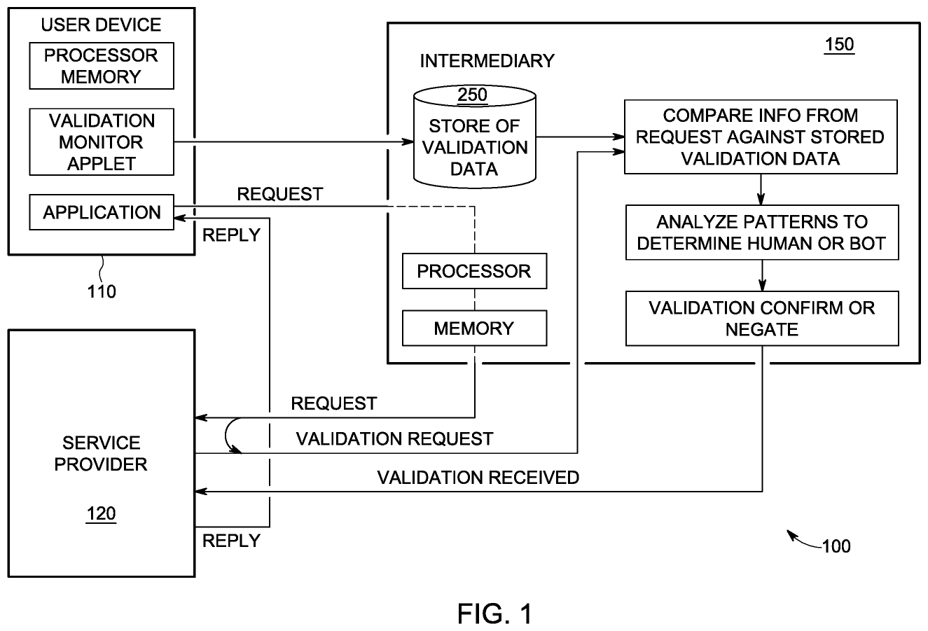

Referring to FIG. 1, validation may be required when a requesting device 110 of the internet requests any form of service or information from a service provider server 120. For example, user device 110 may make a representation of identity or configuration as part of a request for a page from a service provider or publisher 120 of content (cnn.com, ScientificAmerican.com, Sportslllustrated.com, or the like), and the service provider server 120 may ensure that user device 110 is as represented. For example, if service provider server 120 is a bank, financial institution, or payment system, the provider may wish to ensure that a request for a funds transfer or other financial transaction originates with a computer known to belong to the account holder. In a second example, if publisher 120 has a paywall, publisher 120 may wish to validate that the requesting device 110 has a paid subscription, or otherwise has authorized digital rights. As a third example, when an ad is to be served to user device 110, the content provider (whose page will display the ad), the advertiser, or an ad exchange that is intermediating sale of the ad 120, may request validation to ensure that user device 110 is what it claims to be, which in turn may be used to validate that pricing of the ad is correct. Or user device 110 (or a content publisher) may request an ad to be displayed in a rectangle of a page to be displayed, and the request may include certain representations about user device 110 (for example, representations that govern the rate or price to be paid for display of certain advertising content), and ad server or advertiser 120 may wish to validate those representations before delivering the ad. Or user device 110 may be requesting to sign on to a public Wi-Fi hotspot, and the Wi-Fi provider 120 may seek to validate some element of the user device's connection location, ownership, capacity, or security. Or user device 110 may be a device requesting to connect to a paid subscription Wi-Fi service, and the Wi-Fi service 120 may validate that the subscription is in good standing. Or user 110 may be seeking access to some computer or network 120, and validation of device 110 may be a second-factor verification of the user's right to access the computer or network. In some cases, the request includes various parameters of requesting device 110, and various payment amounts or access rights turn on accuracy of those parameters. In such cases, service provider 120 may wish to validate that the requesting device's self-representations are accurate—for example, whether the user device's self-reported location is accurate, whether it is accurately self-reporting itself to be a television, desktop computer, laptop computer, or smartphone, whether device 110 is being operated by a human or by a bot, and the like. When user device 110 requires a web page for display, content server 120 may wish to validate the configuration of user device 110 to ensure that data are provided in a format tailored for the device. This additional check on self-reporting may reduce fraudulent requests for networking services, in payment systems, and in rates for advertising. This may also reduce web traffic by reducing fraudulent message packets, protracted negotiations, and the like.

Validation may be provided by a validation/monitoring applet 200 that runs on the user device to gather information about the device and the activities it performs. This data may be stored in the memory 250 of a validation intermediary 150. When a service provider server receives a request from a user device and needs to validate the request, the service provider server may issue a validation request to a validation module, which may run either on a computer of the validation intermediary or as a validation/monitoring applet 200 on the user device, which can either confirm or reject validation of the request. In some cases that validation request may be a challenge, with some parameter that device 110 has represented, and service provider 120 may challenge with that self-reported parameter. Service provider 120 may issue a query for device 110 to self-report. Because validation/monitoring applet 110 runs at or obtains its information from an operating system layer below the layer at which most applications run, and inquires of the operating system or some trusted source, applet 200 and intermediary 200 may provide a layer of validation to confirm self-reporting by an application.
II. Validation of User Device Properties in Response to Programmatic Request

II.A. General Operation

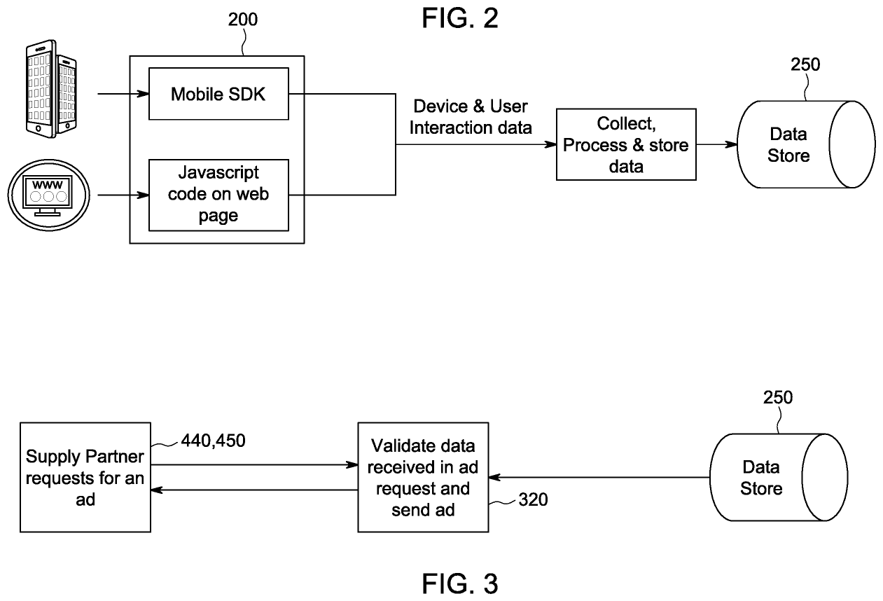

Referring to FIGS. 1 and 2, a small validation/monitoring applet or Javascript module 200 may be installed on the user device 110 to handle requests from computers 120 seeking validation. The validation/monitoring applet 200 on user device 110 may gather various information from low levels in the operating system of device 110, and store 250 them for use in validation. Any particular implementation may collect and store some subset of two, three, four, five, six, seven, eight, nine, ten, or eleven of these events, and may use additional data not listed here.
App Name
App Bundle ID (a unique identifier string assigned by an app developer and registered with iOS—the terms “app ID” and “bundle ID” are interchangeable)
Device ID / Cookie ID
User Agent
Device Type
Operating System
Device Manufacturer
Device Orientation
Location Latitude/longitude
Carrier
IP Address
Active User Session/Interaction
   Data gathered by the validation/monitoring applet 200 may be stored 250 at a validation intermediary server, on the device 110 itself, or elsewhere in the network. When service provider server 120 receives a request originating with user device 110, and needs to validate the request or identity of user device 110, service provider 120 may issue a validation request to validation intermediary 150. Validation intermediary 150 may compare the request to the stored record for the user device, or may infer patterns from the stored data. Based on that comparison or inferences, validation intermediary 150 may either confirm or reject validation of the request.

Validation/monitoring applet 200 obtains its information from a reliable and tamper-resistant interface. Interfaces into the operating system are typically not alterable by application-layer programs, so information from low-level operating system calls are generally reliable and tamper-resistant. In some cases, software that runs at user privilege levels may be protected, validated, tamper-resistant, and reliable, so that it may be relied upon to deliver reliable information to validation/monitoring applet 200.

In some cases, validation/monitoring applet 200 may be implemented as code (for example, Javascript) in a web page of a website that may require validation, and may be invoked on demand as the page is loaded, for validation for a single with the page is viewed over the internet on any user browser or device 110. Validation/monitoring applet 200 may be implemented as a library of routines, or as a single image with multiple entry points. Validation/monitoring applet 200 may be implemented in Javascript or similar interpreted language, or may be compiled for the processor specific to the device. Validation/monitoring applet or Javascript 200 may be developed and tailored to a specific application using a software development kit to be provided to publishers and app developers. Validation/monitoring applet 200 may send the monitoring data to an intermediary server that will evaluate the data as received, and process it on demand for validation. Or the per-invocation data captured by validation/monitoring applet 200 may be stored 250 in a longitudinal store, as a series of snapshots that cumulatively track the device.

Validation/monitoring applet 200 may run as a background task on user device 110 to record various actions and uses of the device on a more-or-less continuous, more-or-less real time basis, to capture longitudinal behavior patterns at the validation intermediary. Validation/monitoring applet 200 may sample its data at a higher sampling rate, and store it on device 110, and send it to validation intermediary in bundled form at a lower reporting rate.

From time to time, a computer of the network may request validation of the user device from the validation intermediary. Validation/monitoring applet 200 and data store 250 at the validation intermediary may capture time-varying properties such as location (latitude and longitude), orientation, motion from accelerometers, typing speed, characteristics of touchscreen gestures, and the like.

Validation/monitoring applet 200 may be implemented as a library of routines, or as a single image with multiple entry points. It may be implemented in Javascript or similar interpreted language, or may be compiled for the processor specific to the device. Validation/monitoring applet or Javascript 200 may be developed and tailored to a specific application using a software development kit to be provided to publishers and app developers.

Data from validation/monitoring applet 200 may be stored 250 at validation intermediary in a server using device ID as a primary key.

Validation/monitoring applet 200 may be implemented as a uniform API or call interface presented to multiple clients, publishers, or others that wish to validate properties of the user or user device, and a set of routines that translate that uniform call interface that is exposed to various clients into calls specific to the operating system of the user device, and then translating the information obtained from a native operating system method to a uniform result to be reported back to the requesting client computer. For example, the left column may be the API call presented to client callers, the center column is the underlying method for requesting information from Apple IOS, and the right column is the method for obtaining information from Google Android:

| Validation | | |
|---|---|---|
| API | Apple IOS | Google Android |
| Device Name | UIDevice.currentDevice.name | android.os.Build.MODEL |
| System | UIDevice.currentDevice. | |

| | |
|---|---|
| Name | systemName |

| | | |
|---|---|---|
| Carrier Name | ctTelephonyNetworkInfo. | (TelephonyManager). |

| | |
|---|---|
| subscriberCellularProvider. | manager.getNetworkOperatorName( ) |

carrierName

| | | |
|---|---|---|
| Network | ctTelephonyNetworkInfo. | ConnectivityManager. |

| | | |
|---|---|---|
| Connection | currentRadioAccessTechnology | getActiveNetworkInfo( ).getType( ) |

Type

| | | |
|---|---|---|
| location | locationManager.location. | Location.latitude |

| | |
|---|---|
| latitude | coordinate.latitude |

| | | |
|---|---|---|
| location | locationManager.location. | location.longitude |

| | |
|---|---|
| longitude | coordinate.longitude |

| | | |
|---|---|---|
| Orientation | UIDevice.currentDevice. | getResources( ).getConfiguration( ). |

| | | |
|---|---|---|
| (portrait vs. | orientation | orientation; |

landscape)

| | | |
|---|---|---|
| Battery Level | UIDevice.currentDevice. | BatteryManager bm = (BatteryManager) |

| | |
|---|---|
| batteryLevel | getSystemService(BATTERY_SERVIC |

E);

int batLevel =

bm.getIntProperty(BatteryManager.
BATTERY_PROPERTY_CAPACITY);

| | | |
|---|---|---|
| Advertising | ASIdentifierManager. | AdvertisingIdClient.getAdvertisingIdInfo |

| | | |
|---|---|---|
| ID | sharedManager. | (getApplicationContext( )); |

advertisingIdentifier.
UUIDString

The information may be collected by validation/monitoring applet 200 on the user device and then passed back to the validation intermediary or to the service provider server by any convenient means. For example, validation/monitoring applet 200 on the user device may return this information to the requesting computer via an HTTP POST request with the relevant data as a Javascript JSON payload in the body of the POST.

A longitudinal record of multiple snapshots of this information may be stored 250 in the user device, and may be called upon when validation of the user device is requested. Alternatively, a validation intermediary may receive this information from the user device on a continuing, more-or-less real time basis, and store it for an extended period of time.

Referring to FIG. 3, from time to time, software 300 running on device 110 or at another computer of the network may inquire to validate a property of device 110, or may directly inquire for a property of user device 110, such as location, device type, whether the user device is being operated by a human being or by a bot, etc. Monitoring and reporting software 320 may analyze current device state and the recorded behavior pattern data, and apply various filters, tests, and heuristics to ascertain properties that can be inferred from the longitudinal data, such as travel patterns to allow the device to select a wireless access point in the likely travel path, whether the device is a human being or a bot, whether the user is driving at the moment, etc. Machine learning algorithms may be used to evaluate recorded data 250. For example, the monitoring and recording can be performed by a Javascript monitor that operates within an internet browser of the user device.

From time to time, a computer of the network may request validation of some parameter of the user device. If the information in the request to be validated matches the validation information captured by validation/monitoring applet 200, the request may be considered valid and service provider service 120 may honor the request. For example, a Wi-Fi hotspot may accept the request, or an ad exchange may place a bid to show an ad requested by the request. Otherwise, the request may be considered fraud, and service provider service 120 may dishonor the request.

II.B. Implementation

Validation/monitoring applet 200 may be implemented as a “tag” (a small bit of code (typically Javascript or HTML) that is incorporated in a publisher's page, to be executed by a user browser when the page is loaded for display, to either retrieve content for display, or as an applet provided to mobile app developers, or by a “pixel” (“pixel” is used in the sense of “a small app delivered to a web page behind a 1×1 or 1×0 pixel display element, so that it can execute without being significantly visible to the user”), or as a background task that runs more or less continuously to collect data about the user, or as some combination of these. A Software Development Kit (SDK) may be provided to various clients of validation/monitoring applet 200, such as publishers that intend to publish ads on their web sites, advertisers that will pay to publish ads, providers of network bandwidth and resources to ensure that users are as they represent themselves to be, and the like.

Javascript of a tag 200 may collect the following attributes when a page is loaded:

Read page URL and document referrer that referred the user to the current page

Set/Read visitor unique ID

Javascript of the tag may also send a signal to an exchange that intermediates requests and responses for services of the class requested by user device 110, or purchases and sales for goods or services requested by user device 110, on following events. Any particular implementation may use some subset of two, three, four, five, or six of these events.

Page Load

Page Unload

Window Close

User navigates to page

User navigates off page

User types Enter to initiate a POST

A pixel may be defined that will collect following data. Any particular implementation may collect some subset of two, three, four, five, six, seven, eight, nine, or ten of these events, and may use additional parameters not listed here.

Application ID {{App ID}}

App Name {{App Name}}

Platform {{Platform}}

Device Name {{Device Name}}

App Bundle ID/Web Page URL

Page Referrer for Web Pages.

IP address.

User Agent.

Location latitude/longitude

Advertiser ID {{Advertiser ID }}

Event {{Event Name }}

Device Orientation

The pixel may be fired for the following events. Any particular implementation may use some subset of two, three, four, five, six, seven, eight, nine, or ten of these events, or may use additional parameters not listed here:

| Event | Android | iOS | definition of event |
|---|---|---|---|
| app_exception | ✓ | | when the app crashes or throws an exception. |
| app_update | | ✓ | when the app is updated to a new version and |
| | | | launched again. The previous app version id is |
| | | | passed as a parameter. |
| | | | This event is conceptually different from the Daily |
| | | | upgrades by device metric, which is reported by |
| | | | Google Play Developer Console. An upgrade |
| | | | refers to the updating of the application binary, |
| | | | whereas an app_update event is triggered upon |
| | | | the subsequent launch of the upgraded app. |
| first_open | | ✓ | the first time a user launches an app after |
| | | | installing or re-installing it. |
| | | | This event is not triggered when a user |
| | | | downloads the app onto a device, but instead |
| | | | when he or she first uses it. To see raw |
| | | | download numbers, look in Google Play |
| | | | Developer Console or in iTunesConnect. |
| in_app_purchase | | ✓ | |
| notification_dismiss | ✓ | | |
| notification_foreground | ✓ | ✓ | |
| notification_open | ✓ | ✓ | |
| notification_receive | ✓ | | |
| os_update | ✓ | ✓ | when the device operating system is updated to |
| | | | a new version. The previous operating system |
| | | | version id is passed as a parameter. |
| screen_view | | | when a screen transition occurs and any of the |
| | | | following criteria are met: |
| | | | No screen was previously set |
| | | | The new screen name differs from the |
| | | | previous screen name |
| | | | The new screen-class name differs from |
| | | | the previous screen-class name |
| | | | The new screen id differs from the previous |
| | | | screen id |
| session_start | ✓ | ✓ | when a user engages the app for more than the |
| | | | minimum session duration after a period of |
| | | | inactivity that exceeds the session timeout |
| | | | duration. |
| user_engagement | ✓ | ✓ | periodically, while the app is in the foreground. |

Information passed from any of the above client side requests may be logged and stored 250 on a disk of a server. Implementation on the server side could include a java servlet application that accepts the HTTP POST requests from the user device validation/monitoring applet 200 and stores the information on the disk, and the disk may be cached in memory for rapid access, using a cache solution such as memcache or aerospike. Storing data in memory 250 allows servers to access the data in real time when a request is received that includes parameters that require validation, and to compare those parameters against known-valid data received during the monitoring phase. The server side application may run on tomcat servers and nginx servers may be used as load balancers.

II.C. Validating a User Device Request

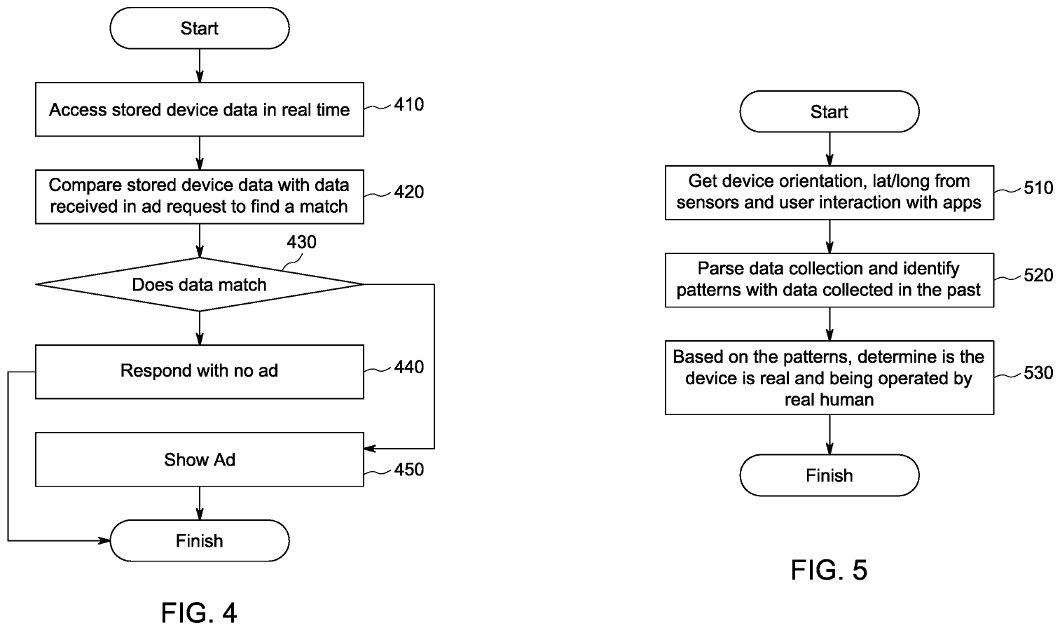

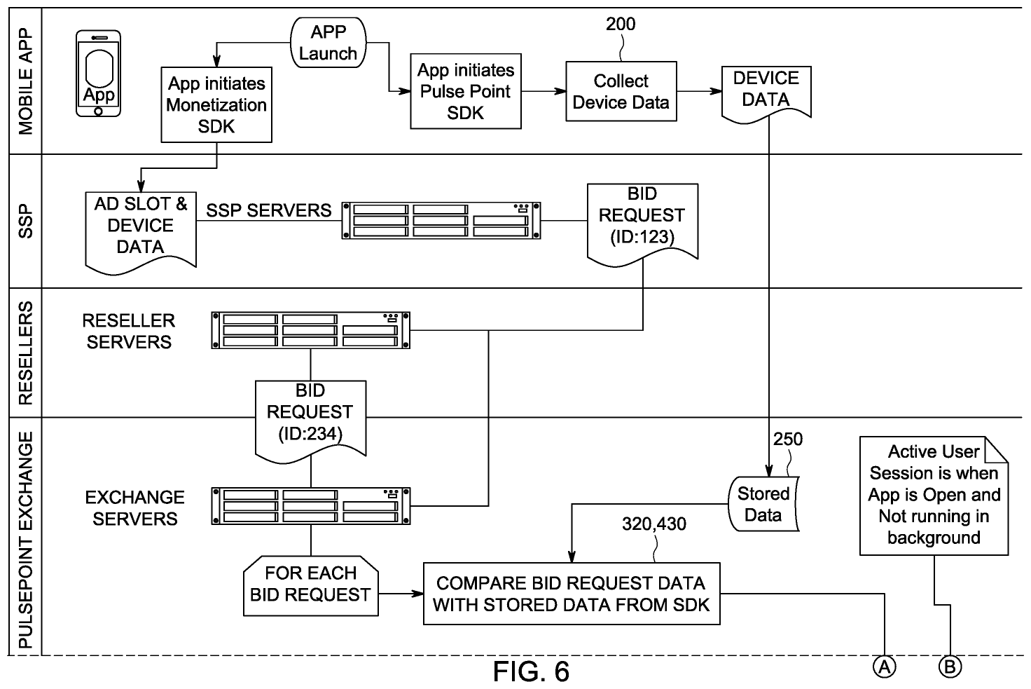

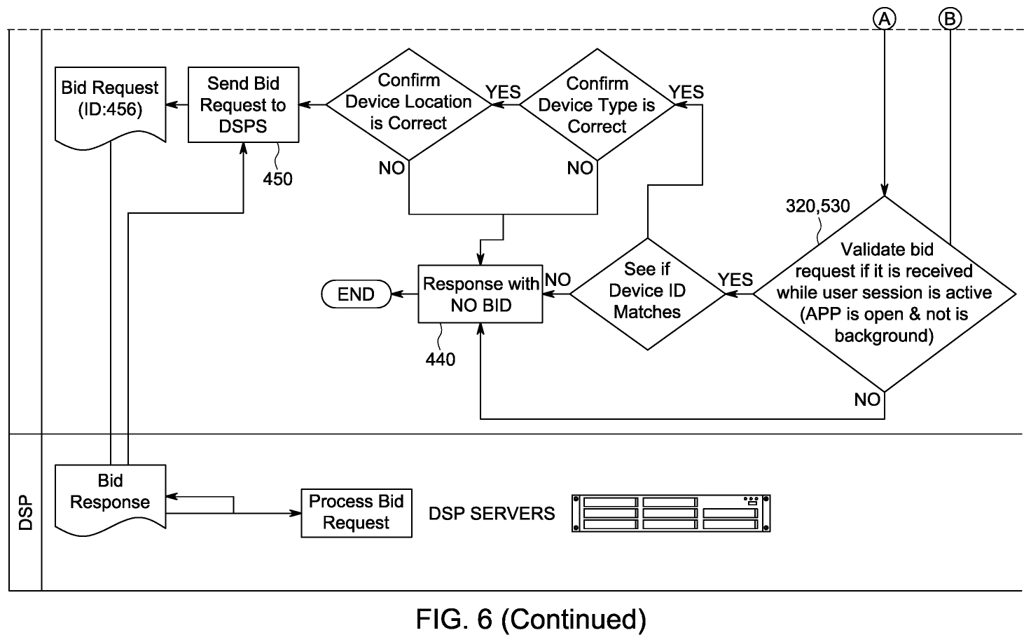

Referring to FIGS. 4 and 6, with this information captured 250, various requests may be validated, and filtered out if the request appears to be invalid. In some cases, a request from user device 110 may pass through the validation intermediary 150, and be validated or blocked before the request is passed on to the service provider service to be serviced. A request message from user device 110 may reach service provider server 120, and service provider server 120 may request validation (step 410) from validation intermediary 150 before service provider server 120 delivers a result to user device 110. Validation intermediary 150 may validate that data supplied by a request from user device 110—which originates with an application, and is therefore vulnerable to falsification—checks (step 420, 430) against the data 250 captured by validation/monitoring applet 200. In either case, data from a specific request from user device 110 reaches validation intermediary 150, and validation intermediary 150 compares the data from the specific request to stored validation data received from validation/monitoring applet 200. If the data match, validation intermediary approves the request (step 450), and the service provider server honors the request from the user device. If the data do not match, then validation intermediary informs (step 440) the service provider server, and it may refuse the request.

II.D. Validating a User Session

An active user session is started when a device user starts using an application or visits a website, and ends when the same user stops interacting with application or leaves the website. As part of validation of a request from a user device, a service provider server may verify that there is an active user session on the device identified in the request, and that the session has the same device ID and website/application ID.

An application may adopt the following rules to define a “valid” user session:

1. A valid user session starts when one of the following events are fired:
a. page_load event from Javascript Tag
b. session_start event is fired through image pixel or the validation/monitoring applet 200
c. The session may be assigned a unique ID by a call to the operating system, by hashing the time value, or by generating a random number with a large enough number of bits that the probability of collision with another random number is vanishingly small.

2. A user session ends when
a. page_unload or window_close event is fired from Javascript tag.
b When the session is inactive for 15 minutes.. This may be detected by absence of any user_engagement event fired from Javascript or validation/monitoring applet 200 for 15 minutes.
c. When an app_background OR app_execution event is fired from validation/monitoring applet 200

Any request from an App and Device ID when there is no valid user session for the corresponding App/Domain and Device ID should be filtered and refused.

In one variant of verification, the unique identifier for the session from validation/monitoring applet 200 is compared with the session identifier received from with this specific request, or from the service provider server, to ensure that the request originates with a known session. If the request passes that level of validation, the information in the validation request (which in turn, either is copied from the request from the user device to the service provider server, or is generated by the service provider server) may be further validated as follows.

II.E. Validating against misrepresented data

When any request is received from the user device, after the request passes the “valid session” test, the source-of-request information in the request may be validated against data from validation/monitoring applet 200 in data store 250. If any of the following attributes do not match, the request may be filtered (step 440) and refused. Any particular implementation may validate based on some subset of two, three, four, five, six, seven, eight, or nine of these parameters, or may use additional parameters not listed here:

user unique ID

Bundle ID

Domain

OS/Platform/Device

Location latitude/longitude

User agent

Device type, make model

Device IP address

Ad size

Machine learning algorithms may be used to match and verify the data received in the request against validation/monitoring data store 250, to identify patterns of misrepresentation.

If all of the attributes of the device received in the request from the user device match the data stored in the server for the device, then the request is validated, and the service provider server may respond with a response to the request. If the data does not match, the service provider server may deny the request.

In some cases, the request from the user device may be modified based on data 250 received from validation/monitoring applet 200. For example, if the request designates one position latitude/longitude value, and validation/monitoring applet 200 or data store 250 indicates another, but the discrepancy is not such as to indicate fraud, the request may be updated with the positional information from the validation/monitoring applet 200 before being forwarded to the server that will actually act on the request.
III. Validation of Human vs. Bot Devices

Referring to FIGS. 5 and 6, user devices operated by automatic bots may be treated differently from user devices operated by humans. For example, servers may dishonor requests for large data transfers during business hours from bots, but honor them from humans. A request for an ad to be displayed may be honored for a human, but refused for a bot. Segregating this way ensures that fees are charged only where appropriate, that web traffic packets carry information that is useful to the recipient, and that web traffic resources are efficiently allocated.

Data 250 collected from the validation/monitoring applet 200 can also be used for identifying bot devices. Bot devices are devices that are operated automatically without any human interaction with the device. Using the data collected from an App on multiple devices, a typical pattern on human interaction can be established (step 520) using attributes and heuristics such as the following, in any subset or combination:
If unusually large number of requests are received from the same device ID with any given time range, it could be considered bot device.
If an app is usually rendered in Portrait orientation by most devices, but a particular device is always rendering the same app in Landscape, that device will be considered a bot device.
Likewise, user devices operated by humans change orientation several times a day. If a user device has not changed orientation in the last 48 hours, it may be a bot.
Position latitude/longitude: mobile phone and laptop devices move, desktops are stationary. If a user request comes from a device with an atypical match between its position data and device type data, the device is likely a bot.
Connection Type: Devices usually switch between Wi-Fi and LTE. If a device is always connected to Wi-Fi/LTE and does not switch, it can be considered a bot.
Length of user sessions. Specific apps usually have typical trends in user sessions. For example, a user session on weather app is typically short (5-10 minutes). A Candy Crush game typically has long sessions. If a device exhibits atypical session durations for a specific app, it can be considered a bot.
Battery Level: Bot devices are usually plugged in to the power source. So, if a device is always plugged in with 100% battery power, which is not the general case with regular devices, that device will be considered a bot.
Humans can type a maximum of about three characters per second. If the user device appears to be “typing” faster than that, it's likely a bot.
Humans move from place to place on the internet. Even humans that are using one web site at work tend to look at email, Amazon, eBay, interspersed with work. If the device is too consistent about what web site it's interacting with for an extended period of time, then it's a bot.
Humans at a stationary computer move hands from keyboard to mouse to keyboard to mouse. Humans at a mobile phone move from typing to finger pinch gestures, to touching buttons. If everything is coming from one input mode, it's a bot.
When a user is mobile, does the user's cell tower changes. A mobile device that is at a single hardware location for an extended period of time (or a stationary device type that moves) is likely a bot.

Machine learning algorithms may be used to match and verify the data received programmatically with data received from human-mediated sources.

All the attributes together can help identify the patterns of the bot. A weighted average method of all these attributes may be used to determine a typical user interaction pattern with each app. Data collected from each app is then matched against the typical pattern to check for anomalies and detect the devices that are behaving abnormal to classify them as bots.

When a request is received from a specific user device 110, the attributes collected for user device 110 may be used to evaluate (step 530) whether the device is being operated by a human or by a bot.
IV. Computer Implementation

A user device or mobile device may be a smartphone, a personal digital assistant

(PDAs), a handheld computer, a personal communicator, a device equipped with J2ME (Java 2 Platform, Micro Edition), a cellular telephone, a “SIP” phone, a personal computer (PCs) or minicomputer, a desktop, laptop, or otherwise, or an internet-of-things device that can make requests of other devices in a network.

The user device may run varying applications, any one or more of which may rely on the validation features discussed above. An application may be executable software that implements a certain functionality or theme. The unit of executable software generally runs in a predetermined environment; for example, the unit could comprise a downloadable Java Xlet™ SDK, or Javascript code that runs in a browser.

Various processes described herein may be implemented by appropriately programmed general purpose computers, special purpose computers, and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hard-wired circuitry or custom hardware may be used in place of, or in combination with, some or all of the software instructions that can implement the processes. Algorithms other than those described may be used.

Programs and data may be stored in various media appropriate to the purpose, or a combination of heterogeneous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices.

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed alternatives, variations, modifications, and equivalents are within the literal scope of the following claims, and others are equivalent. The claims may be practiced without some or all of the specific details described in the specification. In many cases, method steps described in this specification can be performed in different orders than that presented in this specification, or in parallel rather than sequentially, or in different computers of a computer network, rather than all on a single computer.

The invention claimed is:

1. An apparatus, comprising:
one or more processors; and
one or more nontransitory memories, having stored therein programs that, when executed, cause the processor(s):
in the memory of a computer, to store validation data captured by one or more programs running on a user device of the internet, the on-device program(s) having captured the validation data from a tamper-resistant interface on the user device, the validation data describing the user device, software execution on the user device, a unique device ID for the user device, a session ID for a program running on the user device, and position data of the user device;
when a service provider server receives data from the user device requesting a service, by computer, to evaluate the request data and the stored validation data to verify whether the user device is operated by a human as represented in the service request data or is under operation of a bot;
if the verification succeeds, sending a network message to the service provider server that the request is validated as coming from a device operated by a human, and if the verification fails, reporting that the request originated with a device operated by a bot.

2. An apparatus, comprising:
one or more processors; and
one or more nontransitory memories, having stored therein programs that, when executed, cause the processor(s):
in the memory of a computer, to store validation data captured by one or more programs running on a user device of the internet, the on-device program(s) having captured the validation data from a tamper-resistant interface on the user device, the validation data describing the user device, software execution on the user device, a unique device ID for the user device, and a session ID for a program running on the user device;
when a service provider server receives data from the user device requesting a service, by computer, to evaluate the request data and the stored validation data to verify whether the user device is as represented in the service request data;
if the verification succeeds, sending a network message to the service provider server reporting that the request is validated, and if the verification fails, sending a network message to the service provider server reporting that the request is not validated.

3. The apparatus of claim 2,
wherein the validation data further describe position data of the user device;
and wherein the program(s) are further programmed to cause the processor(s):
when a service provider server receives data from the user device requesting a service, by computer, to evaluate the request data and the stored validation data to verify whether the user device is operated by a human or is under operation of a bot; and
to send a computer network message to the service provider server, the message reporting the result of the human vs. bot verification.

4. The apparatus of claim 2, wherein:
for multiple user devices, the multiple user devices running disparate operating systems, the on-device programs expose a uniform API (application program interface) to service provider servers of the internet, to allow service provider servers to obtain validation data from the multiple user devices over the uniform API, without the need to specialize to the disparate operating systems of the respective user devices.

5. The apparatus of claim 2, wherein:
the verification is designed to test for misrepresentation by an application on the user device.

6. The apparatus of claim 2, wherein:
the on-device program is programmed to run substantially continuously in background to collect validation data on the user device, and the validation data are stored longitudinally.

7. The apparatus of claim 6, the program(s) being further programmed to cause the processor(s):
to analyze the stored longitudinal data to analyze a validation property of the user device.

8. The apparatus of claim 2, wherein:
the captured validation data are stored, and the evaluation of request data against validation data are executed, on the user device.

9. The apparatus of claim 2, wherein:
the captured validation data are stored, and comparing of request data against validation data are executed, on a validation server remote from the user device.

10. The apparatus of claim 2, wherein:
the on-device program is programmed to collect information on demand, per invocation by the validation server.

11. The apparatus of claim 10, wherein:
the on-device program is programmed to collect validation information on demand based on occurrence of at least three events from the following list:
Page Load
Page Unload
Window Close
User navigates to page
User navigates off page
User types Enter to initiate a POST

12. The apparatus of claim 2, wherein:
the program(s) are programmed to cause the processor(s), as part of the verification, to test at least five parameters from the following list of parameters:
user unique ID; User session ID; Domain; Operating System or Platform; Device location latitude/longitude; User agent; Device type; Device manufacturer; Device model; Device IP address; Carrier; Ad size; Application ID; App Name; Platform; Device Name; Web Page URL; Page Referrer for Web Pages; IP address; User Agent; Location latitude/longitude; Advertiser ID; Event name; and Device Orientation.

13. The apparatus of claim 2, wherein:
the service request from the user device relates to display of an ad.

14. The apparatus of claim 2, wherein:
the service request from the user device relates to validation for a financial transaction.

15. The apparatus of claim 2, wherein:
the service request from the user device relates to validation for access to digital content.

16. The apparatus of claim 2, wherein:
the service request from the user device relates to validation of access rights to a computer system or network.

17. An apparatus, comprising:
one or more processors; and
one or more nontransitory memories, having stored therein programs that, when executed, cause the processor(s):
to store into the memory of a computer validation data captured by one or more programs running on a user device of the internet, the on-device program(s) having captured the validation data from a tamper-resistant interface on the user device, the validation data describing the user device, software execution on the user device, and position data of the user device;
when a service provider server receives data from the user device requesting a service, by computer, to evaluate the request data and the stored validation data to verify whether the user device is operated by a human or is under operation of a bot; and
to send a computer network message to the service provider server, the message reporting the result of the human vs. bot verification.

18. The apparatus of claim 17, the program(s) being further programmed to cause the processor(s):
to store validation data that includes at least a unique device ID for the user device, and a session ID for a program running on the user device;
to evaluate the request data against the stored validation data, the evaluated data including at least a device ID and session identifier, to verify whether the user device is as represented in the service request data;
if the verification succeeds, sending a network message to the service provider server that the request is validated, and if the verification fails, sending a network message to the service provider server reporting that the request is not validated.

19. The apparatus of claim 17, wherein:
for multiple user devices running disparate operating systems, the on-device program(s) are programmed to expose a uniform API (application program interface) to service provider servers, to allow service provider servers to obtain validation data from the multiple user devices over the uniform API, without the need to specialize to the disparate operating systems of the respective user devices.

20. The apparatus of claim 17, wherein:
the evaluation is programmed to test for misrepresentation by an application on the user device.

21. The apparatus of claim 17, wherein:
evaluation of the stored validation data includes evaluating for an unusually large number of requests received from the same device ID within a recent time interval, relative to other devices or the same device ID for an earlier time interval.

22. The apparatus of claim 17, wherein:
evaluation of the stored validation data includes evaluating for atypical device orientation for a function relative to device orientation usage by other devices performing the same or similar functions.

23. The apparatus of claim 17, wherein:
evaluation of the stored validation data includes evaluating for atypical geographic location or geographic path.

24. The apparatus of claim 17, wherein:
evaluation of the stored validation data includes evaluating for atypical pattern of network connection.

25. The apparatus of claim 17, wherein:
evaluation of the stored validation data includes evaluating for atypical length of user session.

26. The apparatus of claim 17, wherein:
evaluation of the stored validation data includes evaluating for atypical battery usage.

27. The apparatus of claim 17, wherein:
evaluation of the stored validation data includes evaluating for atypical typing pattern or keyboard and mouse usage.

28. The apparatus of claim 17, wherein:
evaluation of the stored validation data includes evaluating for atypical connection destination and duration.

29. The apparatus of claim 17, wherein:
the service request from the user device relates to display of an ad.

30. The apparatus of claim 17, wherein:
the service request from the user device relates validation for a financial transaction.

31. The apparatus of claim 17, wherein:
the service request from the user device relates validation for access to digital content.

32. The apparatus of claim 17, wherein:
the service request from the user device requests validation of access rights to a computer system or network.
